(19) United States
(12) Patent Application Publication
(10) Pub. No.: US 2006/0024053 A1
(43) Pub. Date: Feb. 2, 2006

(54) Apparatus for determining replenishment of chemicals

(75) Inventor: Sidney Grant, London (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: MEDIVANCE INSTRUMENTS LIMITED, London (GB)

(21) Appl. No.: 10/534,852

(22) PCT Filed: May 28, 2003
(86) PCT No.: PCT/GB03/02302

§ 371 Date: May 13, 2005

(30) Foreign Application Priority Data
May 30, 2002 (GB) 0212547.4

(51) Int. Cl. G03B 13/00

(52) U.S. Cl. 396/578

(57) ABSTRACT

A method and system for monitoring when chemicals in a development process need replenishing. The system comprises a reference strip bearing a developed graduated scale of exposure of a radiation sensitive medium to a range of exposures and a testing module comprising a radiation shielded pouch and an unexposed radiation sensitive medium within the pouch. The said module include a radiation filter for producing a graduated scale of a range of exposures to radiation on a test strip when it is exposed to radiation and subsequently developed. The scale on the test strip being identical to that on the reference strip when the test strip is exposed to the same radiation, and developed in a developing bath with an acceptable chemical level and composition as that used to produce the scale on the reference strip. Means are provided for comparing the scales on the reference and test strips side-by-side. The test strip and the reference strip each have a datum indicia that align when the test strip and the reference strips are in a datum position relative to each other where the scale on the test strip matches the scale on the reference strip. One or both strips have limits indicia that together define an acceptable range of variation of the graduated scales of the test strip compared with the test graduated scale of the reference strip when the test strip is moved relative to the graduated scale of the reference strip away from said datum position in a direction along the scale of the reference strip to bring a selected first region of the graduated scale of the test strip in alignment with a matching region of the graduated scale of the reference strip.

This invention relates to photographic, x-ray and neutron radiographic film processing and is particularly concerned in monitoring when the chemicals used in the development process need replenishing in order to ensure uniformity and reliability of the developing process. This is more of a problem with processing methods where large numbers of x-ray or neutron radiography images are being produced, and the interpretation of crucial features of the images are dependent upon clarity of feint, or obscured, details of the developed image.

As the levels of chemicals of the developing bath are depleted or the composition changes, the quality of the resulting images also degrade and there is no reliable way of telling if quality of the image is poor as a result of imperfect development. Therefore important aspects of the image could be missed when looking at an image that is indistinct due to poor processing.

One way of testing whether the chemicals in the developing bath needs replenishing is to run a test exposure of a reference image at the start of a development process, for example at the start of a shift or beginning of a day. However, this would not give any indication of the levels of chemicals or their composition throughout the day.

An object of the present invention is to provide an easy to use apparatus and method for monitoring the efficacy of an x-ray, neutron radiography or photographic development process.

According to one aspect of the present invention there is provided a system for monitoring when chemicals in a development process need replenishing, the system comprising a reference strip bearing a developed graduated image of exposure of a radiation sensitive medium to a range of exposures, a testing module comprising a radiation shielded pouch and an unexposed radiation sensitive medium within the pouch, said module including a radiation filter for producing on the test strip, when it is exposed to radiation and subsequently developed, a graduated scale of a range of exposures to radiation, said scale on the test strip being identical to that on the reference strip when the test strip is exposed to the same radiation as that used tp produce the reference scale and developed in a developing bath with an acceptable chemical level and composition as that used to produce the reference scale, means for comparing the strips side-by-side, the test strip and the reference strip each having indicia that align when the test strip and the reference strips are in a datum position where the scale on the test strip matches the scale on the reference strip, and one or both strips having indicia that together define an acceptable range of variation of the developed graduated scales of the test strip when the test graduated scale of the test strip is moved relative to the graduated scale of the reference strip away from said datum position and along the scale of the reference strip so as to bring a first region of the graduated scale of the test strip in alignment with a second region of the graduated scale of the reference strip.

Preferably, the indicia comprises a reference line on each strip that align with each other when the strips are in the datum position, and one or both of the strips have a second line spaced from the first line in a direction measured along the direction that the scales extend that defines a limit of acceptable relative displacement of the test strip along the scale of the reference strip.

The invention will now be described, by way of an example, with reference to the accompanying drawings in which:

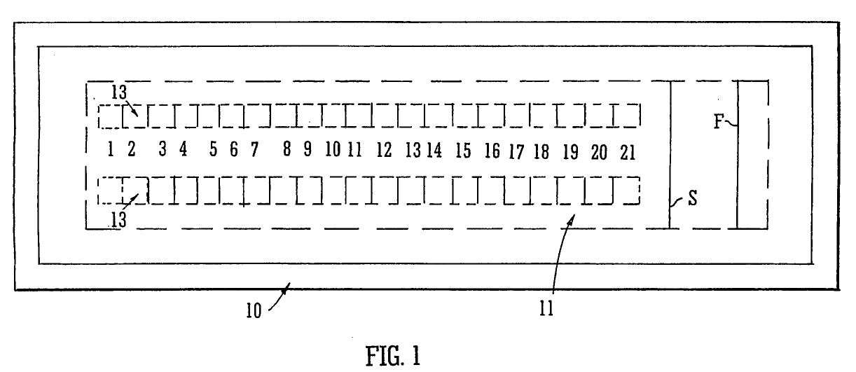

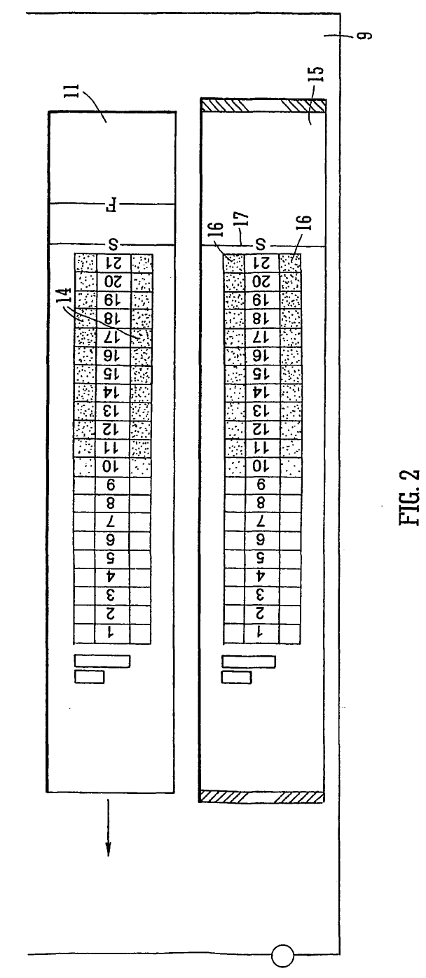

FIGS. 1 to 4 illustrate a portable testing kit constructed in accordance with the present invention, and

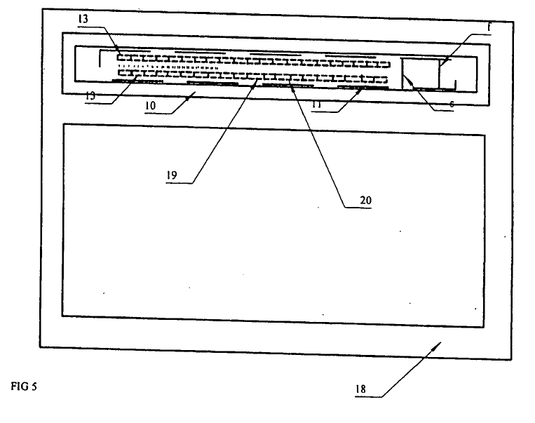

FIG. 5 illustrates a second embodiment of the invention.

Referring to FIG. 1, there is shown schematically a light proof pouch 10 that contains an undeveloped test control strip 11 of x-ray-film. The pouch is provided with a radiation filter or mask 12 that defines two bands 13 of varying thickness so that when the strip 11 is exposed to x-radiation, two graded scales of varying grey scales are produced on the strip when the film is developed. Preferably the band 13 of the filter has uniform step changes in thickness (and hence density) rather than a gradual change in thickness. These step changes are represented in FIG. 1 by the dotted rectangles. The mask 12 is designed so that when there is the correct level of chemicals in the developing bath at the correct composition, the strip 11 will display two parallel scales 14 exhibiting step changes when the film is developed. The test strip 11 has a numerical scale of 1 to 21 printed on it (this may be produced by modifying the mask 12 so that the numerical scale is produced during exposure of the strip 11 to x-rays). The numbers 1 to 21 correspond to each step change of density of the mask 12 and are on an arbitrary scale.

The test strip 11 also has indicia comprising two lines marked “S” and “F” at one end of the scale.

An identical reference strip 15 is produced and developed. Like the test strip 11 the reference strip 15 has two identical scales 16 of graded grey levels or contrasts and a numerical scale of 1 to 21. The reference strip has indicia in the form of a reference line 17 marked at one end of the scales 16. The strip 15 could have two spaced lines S and F identical to those on the test strip 11.

In use, the sealed pouch 10 containing the test strip 11 is exposed to x-radiation and the strip 11 is then removed from the pouch in a darkroom or daylight loading box, and processed in the developing bath. The processed strip 11 is then compared with a reference strip 15 by laying it along side the reference strip.

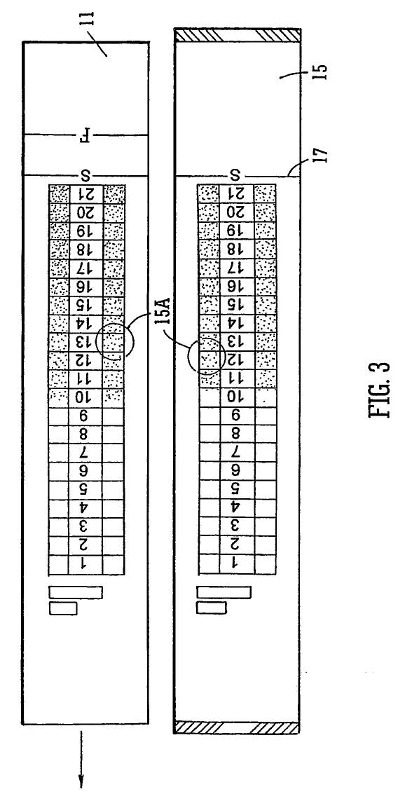

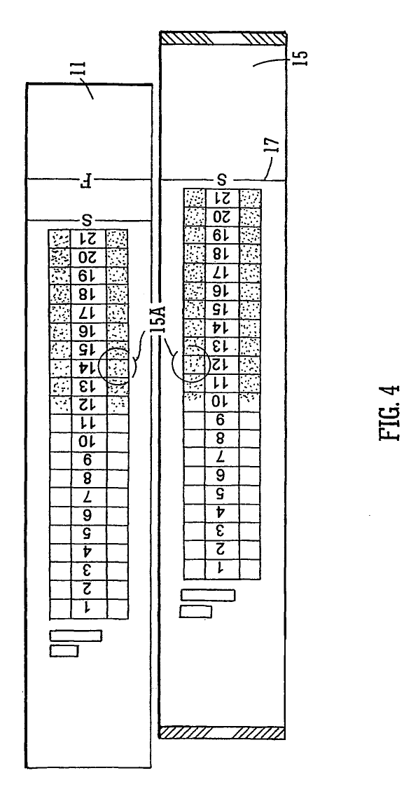

The reference strip 15 is fixed in place on an illuminated background 9 and the test strip is moved axially relative to the reference strip until one of the density steps matches one of the density steps of the reference strip. The circles 15(a) show this in FIGS. 3 and 4.

If the reference line 17 on the reference strip 15 corresponds to the letter “S” or is between the lines “S” (Safe) and “F” (Fail) on the test strip 11, as shown in FIG. 3, then the level of chemicals and the composition of the chemicals in the developing bath is acceptable.

If the reference line 17 on the reference strip 15 aligns with the line “F” on the test strip, or is outside the range of “S” to “F” on the test strip 11, as shown in FIG. 4, then the developing bath chemicals “fail” and must be replenished with fresh chemicals.

In a second embodiment shown in FIG. 5 the test strip 11 is incorporated in the sealed pouch or cassette 18 of the x-ray film along one edge of the film. Either the sealed cassette 18 itself is provided with a graduated radiation filter or mask 19 identical to the filter 12 of FIG. 1, or a separate filter 19 is inserted inside the cassette 18 with the film prior to exposure. When the x-ray film is exposed to x-rays and subsequently developed, the developed x-ray image will incorporate its own test strip 20. This test strip 20 is then compared with a reference strip 15 in the same way as explained above.

This latter embodiment has the advantage that anyone looking at the x-ray image can see if the developing bath was acceptable at the time the x-ray was developed. This may make it easier to interpret x-ray images where the detail is not that good.

It is to be understood that the reference line 17 could be provided on the test strip and the lines “S” and “F” could be provided on the reference strip 15. In either case, the relative positions of the line 17 and the lines “S” and “F” are set so that the reference line 17 falls between “S” and “F” when the chemical levels and composition of the developing bath is acceptable, and falls outside this range when they are not.

In a further embodiment, the test strip may be used in combination with a liquid crystal display panel of the type that includes a display panel shielded from x-rays and light on which patent's details are displayed. With this type of display the data for the displayed image (for example patient's name, date of x-ray, name of consultant, etc.) is entered into the memory of the device so that the details are displayed on an LCD panel against a dark background. The displayed LCD image exposes the x-ray film inside the shielding so that when subsequently developed, the film displays the patient's details. The present invention may be used in three ways with such a display system. In the first way, a test strip 11 in accordance with FIG. 1 is placed inside a light-proof pouch 10 and laid alongside the LCD display where it will be exposed to the x-rays (i.e. outside the shielding of the display panel).

In a second way, the LCD display may incorporate a strip of varying stepped brightness levels corresponding to the step changes of the grey scales in the final developed test strip image so that when the film is exposed and subsequently developed, the test strip 11 of FIG. 1 is produced on the developed x-ray film.

In a third way, a photographic mask is used inside the x-ray and light shielded region adjacent the LCD panel to mask part of the unexposed x-ray film. The x-ray film is exposed by exposing the masked film to a uniform source of light (which could be generated by the LCD display) so as to produce, in the developed x-ray film, the test strip shown in FIG. 1. This test strip is then compared with the reference strip.

In the above examples the film is an x-ray film. It is to be understood that the present invention is applicable to films that have been exposed to light (photographic) or neutrons (neutron radiography).

1-12. (canceled)

13. A system for monitoring when chemicals in a development process need replenishing, characterised by a reference strip bearing a developed graduated scale of exposure of a radiation sensitive medium to a range of exposures, a testing module comprising a radiation shielded pouch and an unexposed radiation sensitive medium within the pouch, said module including a radiation filter for producing a graduated scale of a range of exposures to radiation on a test strip when it is exposed to radiation and subsequently developed, said scale on the test strip being identical to that on the reference strip when the test strip is exposed to the same radiation and developed in a developing bath with an acceptable chemical level and composition, as that used to produce the scale on the reference strip, means for comparing the scales on the reference and test strips side-by-side, the test strip and the reference strip each having a datum indicia that align when the test strip and the reference strips are in a datum position relative to each other where the scale on the test strip matches the scale on the reference strip, and one or both strips having limits indicia that together define an acceptable range of variation of the graduated scales of the test strip compared with the test graduated scale of the reference strip when the test strip is moved relative to the graduated scale of the reference strip away from said datum position in a direction along the scale of the reference strip to bring a selected first region of the graduated scale of the test strip in alignment with a matching region of the graduated scale of the reference strip

14. A system according to claim 13 wherein the datum indicia comprises a reference line on each strip that aligns with each other when the strips are in the datum position, and one or both of the strips have a second line spaced from the first line in a direction measured along the direction that the scales extend that defines a limit of acceptable relative displacement of the test strip along the scale of the reference strip.

15. A system according to claim 13, wherein the pouch is provided with a radiation filter or mask that defines two bands of varying thickness so that when the strip is exposed to radiation, two graded scales of varying grey scales are produced on the strip when the film is developed.

16. A system according to claim 15, wherein the band of the filter has uniform step changes in thickness rather than a gradual change in thickness.

17. A system according to claim 13, wherein the test strip has a numerical scale printed on it corresponding to each step change of density of the mask.

18. A system according to claim 17, wherein the test strip has indicia comprising two lines marked to indicate “safe” and “fail”, respectively, at one end of the scale.

19. A system according to claim 15, wherein the reference strip has identical indicia and markings to that of the test strip.

20. A system according to claim 13, wherein the pouch is incorporated in a cassette of a film plate.

21. A system according to claim 20, wherein the cassette is provided with a graduated radiation filter or mask that creates the graduated scale of the test strip on the film.

22. A method of testing when chemicals in a development process need replenishing comprising the steps of:
a) providing a system according to claim 13;
b) placing a test strip in the sealed pouch and exposing the sealed pouch to radiation;
c) removing the test strip from the pouch in a darkroom environment and processing the test strip in a development bath the composition and contents of which is to be tested to produce a developed test strip;
which is to be tested to produce a developed test strip;
d) comparing the developed test strip with the reference strip by laying the strips alongside each other;
e) moving one strip relative to the other in a direction along the graduated scales until a selected region of the graduated scales of the test strip matches a selected region of the graduated scale of the reference strip and thereby establish a matched position;
f) comparing the position of datum indicia of one of the strips with the limits indicia of the other strip when the strips are in said matched position, and
g) assessing whether the datum indicia of one strip is between the limits indicia of the other strip thereby to assess whether the chemicals in the processing bath need replenishing.

23. A method according to claim 22, wherein the reference strip is fixed in place on an illuminated background and the test strip is moved axially relative to the reference strip until one of the density steps matches one of the density steps of the reference strip.

24. A method according to claim 22, wherein the datum indicia is a reference line and the limits indicia comprise the reference line and a second line.
